(19) United States
(12) Patent Application Publication
(10) Pub. No.: US 2012/0039077 A1
(43) Pub. Date: Feb. 16, 2012

(54) AREA LIGHTING DEVICES AND METHODS

(75) Inventor: John R. Householder, Cedar Park, TX (US)

(73) Assignee: Fraen Corporation, Reading, MA (US)

(21) Appl. No.: 13/208,135

(22) Filed: Aug. 11, 2011

Related U.S. Application Data
(60) Provisional application No. 61/372,781, filed on Aug. 11, 2010.

(51) Int. Cl. F21V 13/04

(52) U.S. Cl. 362/308; 362/327

(57) ABSTRACT

The present application discloses, among other things, optics and lighting devices, systems, and associated methods for delivering light asymmetrically onto a target surface so as to create a desired illumination pattern. Typically, the optics and lighting systems described herein include an optic that receives light from one or more light sources and redirects the light in a patterned or other controlled manner. In many cases, a central lens portion can generate a desired asymmetric illumination pattern while peripheral lens portions redirect light received from the light source to portions of the asymmetric illumination pattern generated by the central lens portion. In many embodiments, the central lens portion redirects light received from a source only via refraction, whereas the peripheral lens portions redirect the light received from the source via a combination of reflection and refraction.

### CROSS REFERENCE TO RELATED APPLICATIONS

This application claims the benefit of priority of U.S. Provisional Application No. 61/372,781, entitled “Area Lighting Devices and Methods” and filed Aug. 11, 2010, which is hereby incorporated by reference in its entirety.

### FIELD

The present invention generally relates to optics and lighting systems, and more particularly to optics and lighting systems for generating an asymmetric lighting pattern, including devices, systems and methods for generating an asymmetric lighting pattern from one or more light sources.

### BACKGROUND

Optics for high-power light sources, such as light emitting diodes, can have a wide variety of configurations. In many cases, a particular configuration can be characterized by the illumination pattern it produces, by the coherence, intensity, efficiency and uniformity of the light it projects, and/or in other ways. The application for which the lens and/or lighting system is designed may demand a high level of performance in many of these areas.

Many applications call for the lens and/or lighting system to direct the light to a target area, while reducing the transmission of stray light beyond the boundaries of a desired illumination pattern. Further, some applications require that light from a light source be manipulated to produce an asymmetric illumination pattern. By way of example, street lamps should be designed to illuminate preferentially the street rather than adjacent areas, even when the light source(s) of the street lamp is not positioned directly over the street. To date, street lighting systems have typically been tilted relative to the plane of the street to direct the light accordingly. However, the uniformity and efficiency of such systems can be limited and their illumination characteristics are typically sub-par.

Accordingly, there is a need for improved area lighting devices, systems and methods, and particularly a need for such lighting devices, systems and methods that can be utilized in street lighting applications.

### SUMMARY

In one aspect, the present invention provides an optic that comprises an input surface adapted for receiving light from a light source, an output surface having a central portion and a pair of side portions, and a pair of reflective sidewalls. The central portion of the output surface has a surface profile and is positioned relative to said input surface such that it refracts light incident thereon via the input surface asymmetrically out of the optic. Further, each of the reflective sidewalls is adapted to reflect light incident thereon via the input surface to a respective one of said side portions of the output surface for exiting the optic.

In some embodiments, the input surface exhibits rotational symmetry about an axis (herein referred to as “central axis”). Further, in some embodiments, the optic can exhibit a plane of mirror symmetry. In some cases, the central axis associated with the input surface can lie in the optic's plane of symmetry.

In some embodiments, the optic is configured such that the light rays that exit the central portion of the output surface in the optic's plane of symmetry diverge asymmetrically relative to the central axis (i.e., the axis of rotational symmetry of the input surface). By way of example, the light rays exiting the optic through the central portion of the output surface in the plane of symmetry can exhibit a maximum divergence angle relative to the central axis on one side of the central axis that is different from a respective maximum divergence angle relative to the central axis on an opposed side of the central axis.

In some embodiments, the optic is configured such that a maximum divergence angle relative to the central axis of light rays that exit the central portion of the output surface in the plane of symmetry on one side of the central axis is equal to or greater than a maximum divergence angle of light rays that exit the optic in the plane of symmetry through a side portion of the output surface that is located on an opposed side of the central axis.

In some embodiments, the optic is configured such that a maximum divergence angle of light rays exiting the optic in the plane of symmetry relative to the central axis is less than a respective maximum divergence angle of the light rays exiting the optic in another plane (“second plane”) that contains the central axis and is perpendicular to the plane of symmetry. In some embodiments, the optic can be asymmetric relative to such a second plane (i.e., the optic lacks minor symmetry about the second plane).

In some embodiments, the optic is configured such that the light rays that exit the central portion of the output surface in the second plane diverge symmetrically relative to the central axis. By way of example, in one embodiment, the light rays exiting the central portion of the output surface in the second plane exhibit a maximum divergence angle of about 70 degrees relative to the central axis on each side of the central axis.

In another aspect, in the above optic, the pair of reflective sidewalls comprises first and second sidewalls, where the angular divergence of light rays (i.e., the angle between two rays representing the boundaries of the bundle of rays) received by the first sidewall from the input surface in the plane of symmetry is less than the angular divergence of light received by the second sidewall from the input surface in the plane of symmetry.

In some embodiments, a minimum distance between the first sidewall and the central axis in the optic's plane of symmetry is greater than a minimum distance between the second sidewall and the central axis in that plane of symmetry.

In some embodiments, the side portions of the output surface intersect with the central portion of the output surface at an intersection point in the plane of symmetry. In one embodiment, the minimum distance between the intersection point and the central axis on one side of the central axis than on the other side of the central axis.

In some embodiments, the central portion of the output surface is positioned relative to the input surface such that a majority of light rays in the plane of symmetry incident on the central portion of the output surface are refracted toward one side of the central axis relative to the other side.

In some embodiments, the central portion of the output surface is positioned relative to the input surface such that light rays traversing the optic in the plane of symmetry exit the central portion of the output surface at an angle in a range of about 0 degree to about 60 degrees relative to the central axis on a first side of the central axis and at an angle in a range of about 0 degree to about 20 degrees relative to the central axis on a second side of the central axis.

In some embodiments, the side portion of the output surface associated with the sidewall on said first side of the central axis (“first side output surface”) is configured such that light rays traversing the optic in the plane of symmetry exit said first side output surface and exhibit an angular divergence (i.e., the angle between two rays representing the two boundaries of the bundle of rays) of about 20 degrees.

In some embodiments, the side portion of the output surface associated with the sidewall on said second side of the central axis (“second side output surface”) is configured such that light rays traversing the optic in the plane of symmetry exit said second side output and exhibit an angular divergence of about 60 degrees.

While in some embodiments, the sidewalls of the optic are configured to reflect light incident thereon via total internal reflection, in other embodiments, the sidewalls are configured to reflect light incident thereon via specular reflection. Such specular reflection of the incident light can be achieved, for example, via metallization of the sidewall surface, e.g., via a thin metal coating.

The output surface of the optic including its central and side portions can be implemented in a variety of ways. By way of example, in some embodiments the central portion of the output surface is formed as two lobes each of which presents a concave surface to the light incident thereon via the input surface. In some embodiments, the side portions of the output surface are substantially planar surfaces. In some implementations, such planar side portions of the output surface can be tilted relative to the central axis of the input surface. The tilt of one side portion relative to the central axis can be different than the tilt of the other side portion relative to the central axis. In some embodiments, one of the side portions of the output surface forms an angle in the optic's plane of symmetry in a range of about 50 degrees to about 70 degrees relative to the central axis and the other side portion forms an angle in a range of about 10 degrees to about 30 degrees in the optic's plane of symmetry relative to the central axis. By way of example, in one embodiment, one of the side portions of the output surface forms an angle in the plane of symmetry of about 60 degrees relative to the central axis and the other side portion forms an angle of about 20 degrees in the plane of symmetry relative to the central axis.

In some embodiments, the optic comprises a unitary structure. In other words, the optic is formed as an undivided whole unit.

The optic can be formed of a variety of materials, which are preferably transparent to visible radiation. By way of example, in some embodiments, the optic can be formed at least partially of one of polymethyl methacrylate (PMMA), glass, polycarbonate, and cyclic olefin polymer.

In another aspect, an optical system is provided that comprises a light source, and an optic having an inferior surface, a superior surface, and a pair of sidewalls extending therebetween, for example, so as to form a central lens portion and two side lens portions. The inferior surface comprises an input portion for receiving light from the light source, where the input portion forms a cavity for at least partially housing the light source. The superior surface in turn comprises a central portion and two side portions, where the central portion of the superior surface is adapted to refract at least a portion of the light received through the input portion out of the optic so as to generate an asymmetric illumination area on a target surface, and the sidewalls are adapted to reflect at least a portion of the light received through the input portion to a respective side portion of the superior surface such that each side portion of the superior surface refracts light incident thereon out of the optic to said asymmetric illumination area.

In some embodiments, the sidewalls are curved so as to present a convex or a concave surface to the light incident thereon via the inferior surface. Further, in some embodiments, the side portions of the superior surface are substantially planar, though in other embodiments they can be curved. In some embodiments, the side portions of the superior surface have different surface areas.

In some embodiments, the light source emits light that can be characterized as having a central propagation axis. For example, the light emitted by the source can exhibit rotational symmetry about such a central propagation axis (the light intensity in a plane perpendicular to the central propagation axis can be rotationally symmetric about the central propagation axis). In some embodiments, the optic can include a plane of symmetry (i.e., a plane through which the optic exhibits minor symmetry) that contains the central propagation axis. In other words, the central propagation axis can lie in the plane of symmetry.

In some embodiments, the input surface of the lens exhibits rotational symmetry about an axis (“central axis”). In some cases, the central propagation axis of the light rays emitted by the source and the central axis of the optic are substantially aligned.

In some embodiments, the optic is positioned relative to the light source such that a majority of light rays exiting the optic in the plane of symmetry are preferentially refracted away from the central propagation axis and toward one side of the central propagation axis (and/or the central axis) relative to the other side.

In some embodiments, the side portions of the superior surface are substantially planar. In such cases, an angle of each side portion relative to the central propagation axis can be defined as the angle between a line segment representing the intersection of the side portion with the optic's plane of symmetry and the central propagation axis. In some such embodiments, the side portions have different angles relative to the central propagation axis.

In some embodiments, a minimum distance between one side portion of the superior surface and the central propagation axis is greater than a minimum distance between the other side portion of the superior surface and the central propagation axis.

In some embodiments, the optic is configured such that light rays that traverse the optic in the plane of symmetry and exit the optic through the central portion diverge asymmetrically relative to said central propagation axis.

In some embodiments, the optic is configured such that light rays that traverse the optic in the plane of symmetry and exit the optic through the central portion of the superior surface exhibit a maximum divergence angle on one side of the central propagation axis that is different from a maximum divergence angle on an opposed side of the central propagation axis.

In some embodiments, the optic is configured such that a maximum divergence angle relative to the central propagation axis of light rays exiting the optic through the central portion of the superior surface in the plane of symmetry on one side of the central propagation axis is equal to or greater than an angular divergence of light rays exiting the optic through a side portion of the superior surface that is located on an opposed side of the central propagation axis.

In some embodiments, the optic is configured such that the light rays that traverse the optic in the plane of symmetry and exit the optic through the superior surface exhibit a maximum divergence angle that is less than a maximum divergence angle exhibited by the light rays that traverse the optic in another plane that is perpendicular to the plane of symmetry and contains the central propagation axis (“second plane”) and exit the optic through the superior surface.

In some embodiments, the light rays that traverse the optic in said second plane to exit the optic through the superior surface diverge symmetrically relative to the central propagation axis.

In some embodiments, the optic is asymmetric relative to the second plane, i.e., it does not exhibit minor symmetry about the second plane.

In some embodiments, the input surface exhibits rotational symmetry about a central axis. In some embodiments, the central axis and the central propagation axis are aligned. In some embodiments, the minimum distance between one side portion of the superior surface and the central axis is greater than a minimum distance between the other side portion of the superior surface and the central axis.

In another aspect, a lighting system is disclosed that comprises a pole disposed adjacent to a target surface, and at least one lighting module mounted on said pole, where the lighting module comprises a light source and an optic for directing light from said source to said target surface. The optic comprises a central refractive portion and a pair of side portions, where the central refractive portion has a cavity for at least partially receiving said light source and for coupling light from said light source into the optic. The central refractive portion further includes an output surface adapted to refract at least a portion of light received through the input surface out of the optic so as to generate an asymmetric illumination area on said target surface. Each side portion is adapted to redirect at least portion of the light received through the input surface out of the optic—via reflection and refraction—to said asymmetric lighting area.

In some embodiments, the lighting module is mounted such that one of said side portions (“proximal side portion”) is disposed proximal to said pole and the other side portion (“distal side portion”) is disposed distal to the pole.

In some embodiments, the light emitted by the light source is characterized by a central propagation axis. In some implementations, the lighting module is mounted on the pole such that the central propagation axis is substantially parallel to a central longitudinal axis of the pole.

In some embodiments, in the above lighting module, the optic exhibits a plane of symmetry and the central propagation axis lies in said plane of symmetry.

In some embodiments, the optic is configured such that the light rays exiting the output surface of said central refractive portion in said plane of symmetry diverge asymmetrically relative to said central propagation axis.

In some embodiments, the optic is configured such that light rays exiting said output surface of the central refractive portion in said plane of symmetry exhibit a maximum divergence angle relative to the central axis on a distal side of said central propagation axis that is greater than a maximum divergence angle relative to the central axis on a proximal side of said central propagation axis.

In some embodiments, the proximal side portion can comprise a proximal sidewall and a proximal output surface and the distal side portion can comprise a distal sidewall and a distal output surface. The proximal sidewall can be configured such that substantially all light received from the input surface at the proximal sidewall is reflected to exit the optic through the proximal output surface, and the distal sidewall is configured such that substantially all light received from the input surface at the distal sidewall is reflected to exit the optic through the distal output surface.

In some embodiments, a maximum divergence angle relative to the central axis of light rays exiting said output surface of the central refractive portion in the plane of symmetry on said distal side of the central propagation axis is equal to or greater than an angular divergence of light rays exiting the proximal output surface in said plane of symmetry.

In some embodiments, a maximum divergence angle relative to the central axis of light rays exiting the output surface of the central refractive portion in said plane of symmetry on said proximal side of the central propagation axis is equal to or greater than an angular divergence of light rays exiting the distal output surface in said plane of symmetry.

In some embodiments, the optic is positioned relative to the light source such that in the plane of symmetry, a majority of light received through the input surface exits the output surface distal to the central propagation axis.

### BRIEF DESCRIPTION OF THE DRAWINGS

A further understanding of various aspects of the application can be obtained by reference to the following detailed description in conjunction with the associated drawings, in which:

FIG. 1 depicts a perspective view of one embodiment of a lighting system according to the teachings of the invention having an optic and a light source;

FIG. 2 depicts another perspective view of the system shown in FIG. 1;

FIG. 3 shows a plan view of the system shown in FIG. 1;

FIG. 4 shows an another plan view of the system shown in FIG. 1;

FIG. 5 depicts a plane of symmetry of the optic of the system shown in FIG. 1 as well as a plane perpendicular to the plane of symmetry;

FIG. 6 schematically depicts a partial cross-sectional view of the system shown in FIG. 1, the cross-section being in the plane of symmetry of the optic with exemplary ray traces representing light emitted from the light source and traversing through the optic;

FIG. 7 schematically depicts another partial cross-sectional view of the system shown in FIG. 1, in a plane perpendicular to the plane of symmetry and containing the central propagation axis of the source, with exemplary ray traces representing light emitted from the light source and traversing through the optic;

FIG. 8 schematically depicts a partial cross-sectional view in the plane of symmetry of an exemplary embodiment of an optic according to the teachings of the invention;

FIG. 9 schematically depicts boundary rays of light exiting the optic of FIG. 8 in the optic's plane of symmetry;

FIG. 10 depicts one embodiment of a lighting system according to the teachings of the invention for illuminating a target surface, such as a street.

### DETAILED DESCRIPTION

The present application discloses, among other things, optics and lighting devices, systems, and associated methods for delivering light asymmetrically onto a target surface so as to create a desired illumination pattern. Typically, the optics and lighting systems described herein include an optic that receives light from one or more light sources and redirects the light in a patterned or other controlled manner. In many cases, a central lens portion can generate a desired asymmetric illumination pattern while peripheral lens portions redirect light received from the light source to portions of the asymmetric illumination pattern generated by the central lens portion. In many embodiments, the central lens portion redirects light received from a source only via refraction, whereas the peripheral lens portions redirect the light received from the source via a combination of reflection and refraction.

In some embodiments, such redirection of the source light by the peripheral lens portions can improve the uniformity of light intensity throughout the pattern and/or prevent light from being directed to undesirable directions (e.g., outside of the asymmetric pattern generated by the central lens portion). In many cases, such an optic can reduce losses associated with prior art lighting systems in which a substantial amount of light generated by the lighting source may fail to illuminate a desired area on a target surface, or indeed, miss the target surface altogether. Further, in some embodiments, multiple optics and their associated light sources (i.e., lighting modules) can be used together to generate an illumination pattern on a target surface. By way of example, the modules can be positioned relative to one another such that the pattern generated by each individual module at least partially overlaps (and in some cases substantially coincides) with the illumination pattern(s) generated by one or more of the other modules to form a desired overall illumination pattern.

The devices, systems, and methods disclosed herein can be used with a wide variety of light sources, including light emitting diodes and incandescent bulbs, or other coherent or non-coherent light sources. Such devices, systems, and methods incorporating the teachings herein can have a wide range of applications, including, for example, street lighting, spot lighting, customizable/adjustable lighting systems, household lighting, flashlights, wearable headlamps or other body-mounted lighting, among others.

Throughout this application, the term “e.g.” will be used as an abbreviation of the non-limiting term “for example.” It should be understood that regardless of whether explicitly stated or not, all characteristics of the optics described herein are by way of example only, and not necessarily requirements. All figures merely depict exemplary embodiments of the invention.

Directional terms such as “proximal,” “superior,” and “anterior” will be used to describe various portions of the optics. These directional terms are merely used as a naming convention to describe the relationship of various parts of the optic relative to one another. These terms do not, however, necessarily indicate a particular orientation or disposition of the optics or systems in use. For example, though an output surface of a lens may be described as “superior,” the system can be oriented such that light from the light source exits the “superior” surface of the lens in a downward direction (e.g., towards the ground).

Further, in some embodiments discussed below, various features of an optic according to the teachings of the invention are discussed with reference to the way the optic redirects light rays incident thereon. For this discussion, it is generally assumed that the light rays are emitted from a putative point source and illuminate an input surface of the optic substantially uniformly. Such light rays can be simulated by ray-tracing software, or they can be provided by a physical light source, such as an LED. It should be understood that the optics and the lighting systems according to the teachings of the invention can be utilized with and can incorporate a variety of light sources. In some cases, such a light source can have a size small enough relative to the size of the optic to be considered as a point source, while in other cases the size of the light source can be comparable to that of the optic. Further, while in some cases the light from such a source illuminates the input surface of the optic substantially uniformly, in other cases the light rays can provide a non-uniform illumination of the optic's input surface.

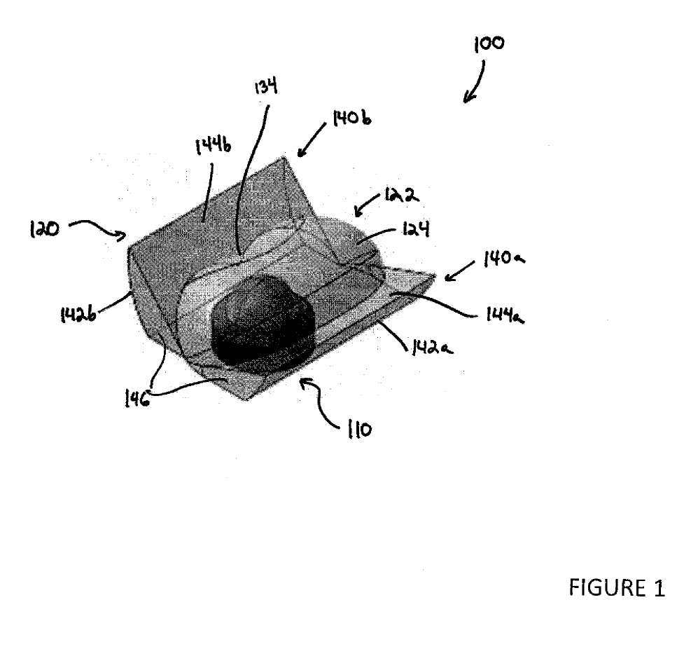

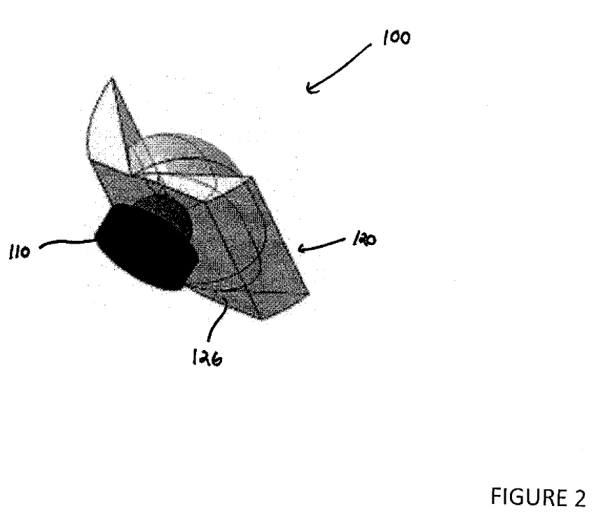

Turning to FIGS. 1 and 2, one exemplary embodiment of a lighting system or lighting module 100 can include an optic 120 and a light source 110. In this embodiment, the optic 120 includes side portions 140a,b and a central refractive portion 122 disposed therebetween. The central refractive portion 122 includes a superior surface 124 and an inferior surface 126, as best shown in FIG. 2. Each of the side portions 140a,b, which can be unitary with the central refractive portion 122, includes a reflective sidewall 142a,b and a side output surface 144a,b associated therewith. The side portions 140a,b can be bounded by lateral surfaces 146.

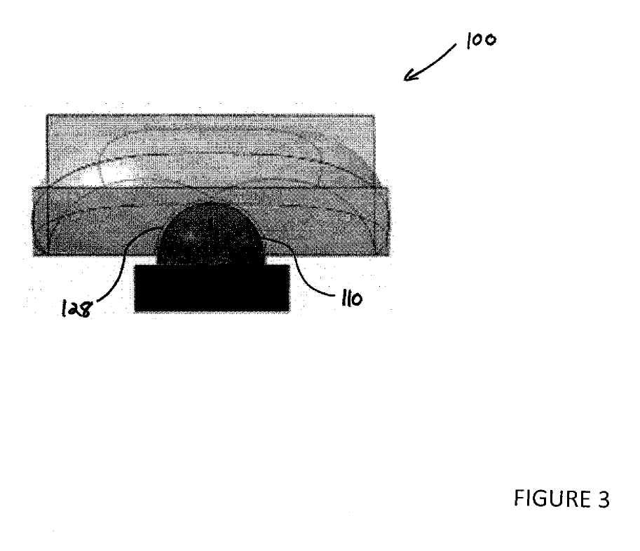

The inferior surface 126 of the central refractive portion 122 is generally configured to couple light from a light source into the optic 120 through at least a portion thereof (herein also referred to as “input surface”) and can have a variety of configurations. In the embodiment depicted in FIGS. 1-4, the input surface 128 forms a recess or cavity in the inferior surface 126, which can house at least partially one or more light source(s). Although any number of light sources can be employed, FIG. 1 shows a single light source 110, such as a light emitting diode, that is disposed at least partially within the cavity of the optic 120. In some embodiments, however, the light source 110 can be disposed outside of the cavity such that the input portion only receives the light from the light source, rather than the light source 110 itself. Regardless, the input surface 128 receives light from the light source 110 and is configured to couple the light from the light source 110 into the optic 120, for example, via refraction at the input surface 128.

The term “refraction” is used herein consistent with it ordinary meaning in the art and refers to the passage of light rays from one medium having one index of refraction (e.g., air outside the optic 120) to another medium having a different index of refraction (e.g., the material forming the optic 120). The refraction of light rays at the interface of two such media can lead to deflection of the rays (i.e., for light rays incident on the interface in non-orthogonal directions). As one skilled in the art will understand, some light from the light source 110 can enter the optic 120 without redirection, for example, if they strike the input surface 128 in a direction normal to the surface.

The input surface 128 can have a variety of configurations to couple light from the light source 110 into the optic 120. By way of non-limiting example, the input surface 128 can present a substantially concave surface to the light rays emitted by the light source 110 such that the refraction of the light rays at the input surface 128 for entry into the optic can cause their divergence. Alternatively, for example, the input surface 128 can present a convex surface, or even planar surface to the light source 110 for coupling the light into the optic 120.

As shown in FIGS. 1-4, in this embodiment the input surface 128 is in the form of a hemispherical surface that is rotationally symmetric about a central axis 132. In other embodiments, the input surface may lack an axis of rotational symmetry. The light source 110, which as shown emits light characterized by a central propagation axis 112, is positioned within the cavity defined by the hemispherical surface such that the central propagation axis 112 and the central axis 132 of the input surface 128 are substantially aligned. In some embodiments, however, various portions of the input surface 128 can be irregular, or the light source 110 can be positioned relative to the input surface 128 such that light from the light source 110 is refracted asymmetrically into the optic 120 by the input surface 128. In some embodiments, for example, the input surface 128 can be configured to redirect light within the optic 120 with an asymmetric distribution such that the ultimate asymmetric distribution of light exiting the optic 120 can be through the combined effect of the input and output surfaces.

The superior surface 124 of the central refractive portion 122 can have a variety of configurations to refract light incident thereon out of the optic asymmetrically, e.g., to generate an asymmetric illumination pattern on a target surface. That is, the central refractive portion 122 can refract light rays incident thereon out of the optic such that the exiting light rays lack an axis of rotational symmetry. For example, in this embodiment, the light rays exiting the optic 120 through the central refractive portion 122 do not exhibit rotational symmetry relative to the central axis 132. In other words, an illumination pattern (characterized by an intensity distribution of light) generated by the light rays exiting the optic through the central refractive portion 122 on a target surface perpendicular to the central axis lacks rotational symmetry. For example, such an illumination pattern can be substantially rectangular, elliptical, square, hexagonal, or in fact, can exhibit an irregular shape.

As shown in FIGS. 1-4, in this embodiment, the superior surface 124 is a continuously curved surface that extends between the side output surfaces 144a,b. Though the superior surface 124 generally presents a concave surface to light transmitted thereto from the input surface 128, various portions of the superior surface 124 can include features that alter the propagation of light therethrough in different ways. By way of example, the superior surface 124 shown in FIGS. 1-4 includes a trough 134 formed in the superior surface 124 near its intersection with one of the side output surfaces 144b. Thus, whereas most of the superior surface 124 acts to diverge light incident thereon from the input surface (i.e., the surface has a negative optical power), at least a portion of the superior surface 124 is shaped as the trough 134 that converges the light exiting therethrough. In this embodiment, the superior surface 124 is shaped and positioned relative to the input surface 128 such that the light incident on the superior surface 124 can be refracted asymmetrically out of the optic 120. In this embodiment, the superior surface 124 lacks rotational symmetry, but includes one plane of minor symmetry. In other embodiments, the superior surface 124 can have an axis of rotational symmetry but can be positioned relative to the input surface (e.g., with an offset between the central axis of the input surface and the axis of rotational symmetry of the superior surface) so as to refract light received from the input surface asymmetrically out of the optic.

The side portions 140a,b can also have a variety of configurations, but generally, are configured to redirect light rays received from the input surface such that most of the rays exiting the optic through the side portions intersect the light rays exiting the optic through the central refractive portion. For example, in this embodiment, the side portions 140a,b are configured to redirect light received from the input surface such that it exits the optic 120 to portions of an asymmetric illumination pattern generated by the superior surface 124 of the central refractive portion 122 on a target surface. In some embodiments, some light rays (e.g., some stray rays) exiting the superior surface 124 near the side output surfaces 144a,b can impinge on the side output surfaces 144a,b and be reflected thereby or re-enter the optic 120 and be reflected by the sidewalls 142a,b (e.g., be reflected back to the side output surfaces 144a,b through which they would again exit the optic or be reflected towards another portion of the optic 120) or transmitted therethrough (e.g., if the angle is less than the critical angle of a TIR surface of the sidewalls 142a,b).

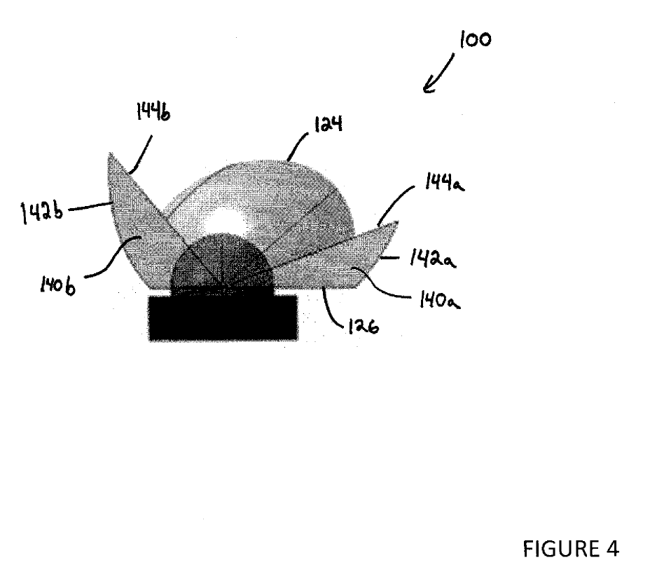

As best shown in the view of FIG. 4, in this embodiment, each of the side portions 140a,b includes a curved reflective sidewall 142a,b and a planar side output surface 144a,b. As will be discussed in detail below, the size, curvature, and orientation of the sidewalls 142a,b and side output surfaces 144a,b relative to the input surface can be configured to controllably redirect the light out of the optic 120. For example, the sidewalls 142a,b can be curved so as to present a concave surface to the light incident thereon via the input surface 128. In other embodiments, the sidewalls 142a,b or a portion thereof can also present a convex or planar surface to the incident light. While in this embodiment the side output surfaces 144a,b are planar, in other embodiments, they can be curved, e.g., they can present concave or convex surfaces to incident light rays.

The reflective sidewalls 142a,b can be configured to reflect light via a wide range of mechanisms, for example, via total internal reflection (TIR) or via specular reflection, which can be achieved. e.g., by metalizing (e.g., forming a metallic coating) on the sidewalls. Further, in some embodiments, one sidewall can employ one mechanism for reflecting the light incident thereon (e.g., TIR) and the other sidewall can employ a different mechanism for reflecting the light incident thereon (e.g., specular reflection).

As is known in the art, total internal reflection can occur at an interface between two media having different indices of refraction when the light traversing the medium having the larger index is incident on the interface at an angle relative to a normal to the interface that exceeds a critical angle, which can be defined by the following relation:

$${θ}_{crit} = arcsin \frac{{n}_{2}}{{n}_{1}}$$

where n₁ is the refractive index of the medium having the larger index and n₂ is the refractive index of the medium having the lower refractive index.

The lateral surfaces 146 can also have a variety of configurations. For example, light incident thereon can exit the optic 120 through the lateral surface (e.g. via refraction). In some embodiments, the lateral surfaces 146 can be metalized so as to redirect the light back into the optic 120 to thereby increase the efficiency of the lens. In some embodiments, the optic 120 can be shaped to minimize the incidence of light on the lateral surfaces.

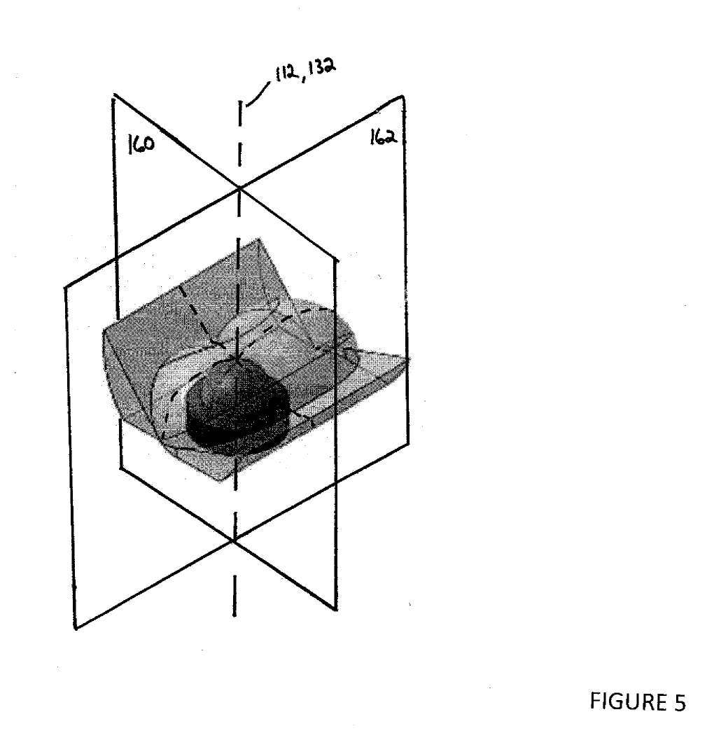

In some embodiments, the lighting system 100, and indeed the optic 120 itself, can exhibit at least one plane of symmetry. For example, with reference now to FIG. 5, the optic 120 includes an input surface 128 rotationally symmetric about a central axis 132, as described above. Further, in this embodiment, the optic 120 exhibits minor symmetry about a plane 160 that contains the central axis 132. In other words, the putative plane 160 bisects the optic into two symmetrical portions. Additionally, in this exemplary embodiment, the central axis 132 and the central propagation axis 112 are aligned such that the plane of symmetry 160 also contains the central propagation axis 112. In addition, in this embodiment, the central refractive portion 122 also exhibits mirror symmetry about the plane 160. A putative second plane 162, also shown in FIG. 5, is perpendicular to the plane of symmetry 160 and includes the central axis 132.

The propagation of light through an optic will be discussed in further detail below, but generally, the light that enters the optic 120 through the input surface 128 (or at least a portion of the light) is conveyed through the optic 120 to each of the superior surface 124 and the sidewalls 142a,b. Light incident on the superior surface 124 of the central refractive portion 122 exits the optic 120 (e.g., via refraction) through the superior surface 124 and propagates, e.g., towards a target surface. As discussed in more detail below, the light can exit the optic through the central refractive portion 122 asymmetrically. The light rays from the light source 110 that enter the optic 120 through the input surface 128 at angles such that they are transmitted to the sidewalls 142a,b are thereby reflected by each of the sidewalls 142a,b, in this embodiment via total internal reflection, towards a respective one of the side output surfaces 144a,b. The reflected rays then exit the optic 120 through the output surfaces 144a,b of the side portions 140a,b (e.g., via refraction at those surfaces) and propagate, e.g., towards a target surface.

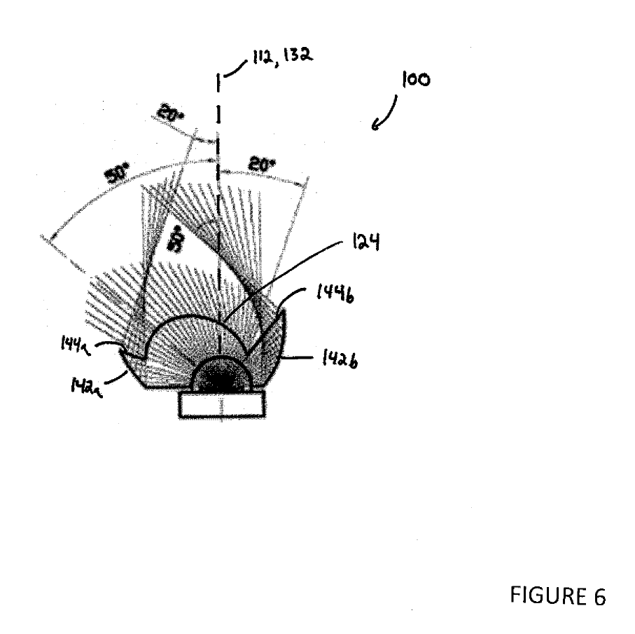

FIG. 6 depicts an exemplary ray trace in the plane of symmetry 160 of the optic 120, illustrating light rays originating at light source 110 that impinge on the input surface 128 of the inferior portion 126. Some of the light rays are refracted at the input surface 128 so as to propagate to the superior surface 124 of the central refractive portion 122. At the superior surface 124, these rays are refracted to exit the optic 120. In this embodiment, the light rays exiting the optic in the plane of symmetry 160 through the superior surface 124 of the central refractive portion 122 exhibit asymmetry relative to central axis 132, which in this embodiment is substantially aligned with the central propagation axis 112. That is, the superior surface 124 can redirect light rays out of the optic 120 such that the illumination pattern (characterized by an intensity distribution of light) generated by the light rays exiting the superior surface 124 on a target surface perpendicular to the central axis 132 lacks rotational symmetry. By way of non-limiting example, more light rays exiting the optic 112 in the plane of symmetry 160 are directed to one side of the central axis 132 than to the other.

With continued reference to FIG. 6, the light rays exit the superior surface 124 of the central refractive portion 122 in the plane of symmetry 160 with a maximum divergence angle of about 60 degrees relative to the central propagation axis 112 on one side (i.e., to the left in FIG. 6) of the central propagation axis 112 and a maximum divergence angle of about 20 degrees on the other side (i.e., to the right in FIG. 6).

Some of the light rays emitted by the light source 110 that are incident on the input surface 128 are refracted at that surface so as to propagate through the optic 120 to the reflective sidewall 142a on one side (i.e., to the left in FIG. 6) of the central propagation axis 112. The reflective sidewall 142a reflects these rays to the side output surface 144a. At the side output surface 144a, these rays are refracted to exit the optic 120. As depicted in FIG. 6, a portion of those light rays exit the side output surface 144a in the plane of symmetry toward the central axis 132, converge to a point, and continue to propagate therefrom at an angular divergence of about 20 degrees.

Some of the light rays emitted by the light source that are incident on the input surface 128 are refracted at that surface so as to propagate through the optic 120 to the reflective sidewall 142b on the other side (i.e., to the right in FIG. 6B) of the central propagation axis 112. The reflective sidewall 142b reflects these rays to the side output surface 144b. At the side output surface 144b, these rays are refracted to exit the optic 120. As depicted in FIG. 6, a portion of those rays exit the side output surface 144b in the plane of symmetry toward the central axis 132, converge to a point, and continue to propagate therefrom at an angular divergence of about 50 degrees.

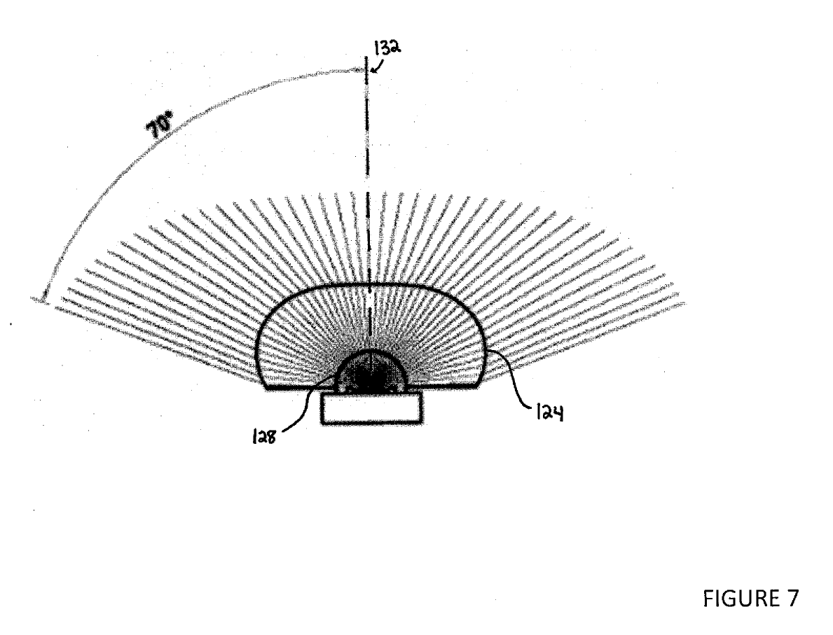

FIG. 7 illustrates an exemplary ray trace in a putative second plane 162 of the optic 120 that is perpendicular to the symmetry plane 160 and includes the central axis 132. The illustrated light rays originate at light source 110 and impinge on the input surface 128 of the inferior portion 126 and are refracted at the input surface 128 to enter the optic 120 and propagate to the superior surface 124 of the central refractive portion 122. At the superior surface 124, these rays are refracted to exit the optic 120. As depicted in FIG. 7, the light rays exit the superior surface 124 of the central refractive portion 122 in the second plane 162 symmetrically relative to the central axis 132. In this embodiment, the maximum divergence angle of light from the central refractive portion in the putative second plane is about 70 degrees relative to the central axis 132.

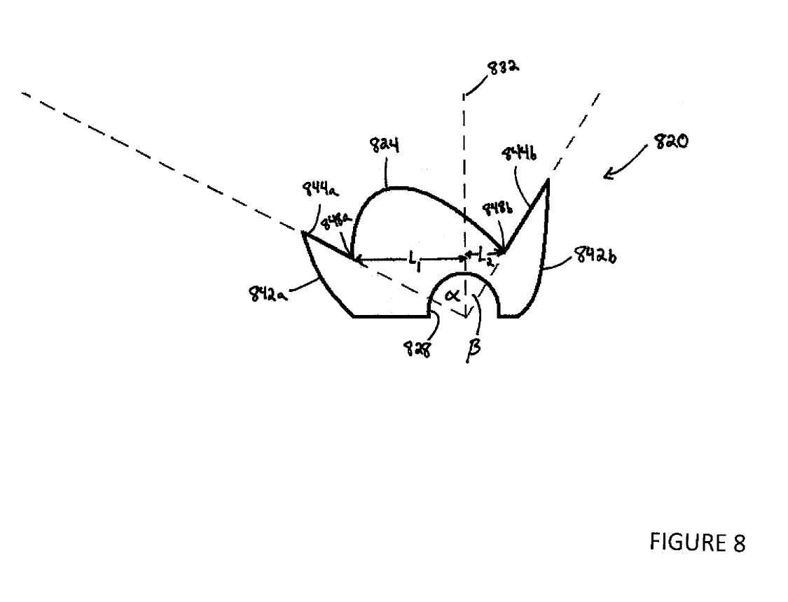

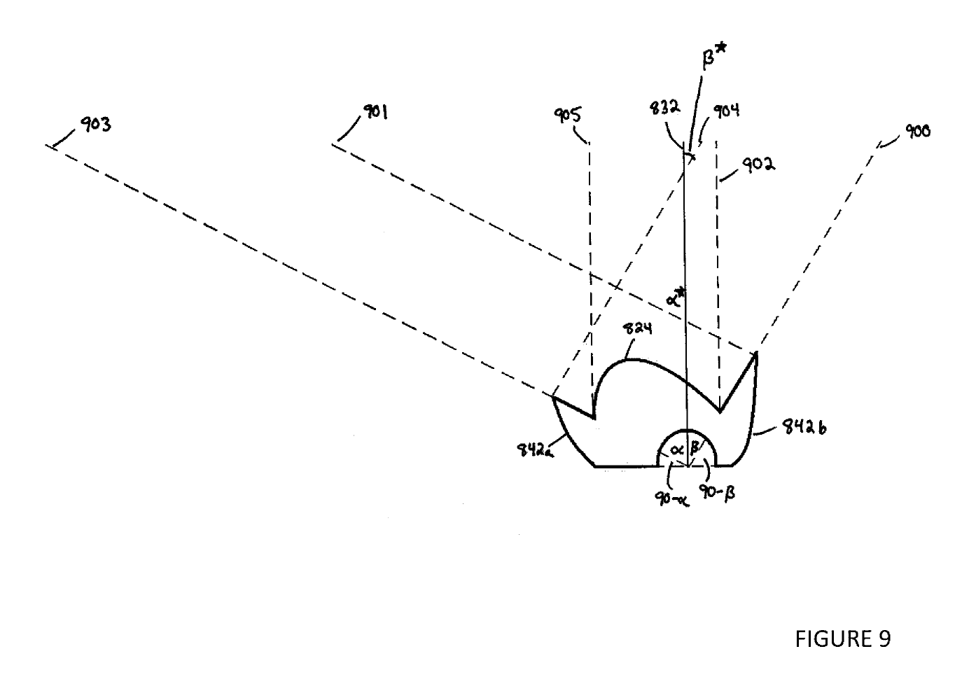

Turning to FIGS. 8 and 9, another exemplary implementation of the optic 120 (herein referred to as optic 820) is shown. In this implementation, the optic 820 includes an output surface having two side portions 844a,b and a central portion 824. Each of the side portions 840a,b is associated with a reflective sidewall 842a,b. The optic 820 also includes an inferior surface 826 having an input surface 828, which forms a cavity for receiving light from a light source (not shown). As shown, the input surface 828 is in the form of a hemispherical surface that is rotationally symmetric about a central axis 832.

Further, in this embodiment, the optic 820 exhibits minor symmetry about a plane 860 that contains the central axis 832. In other words, the putative plane 860 bisects the optic into two symmetrical portions. Additionally, in this exemplary embodiment, a putative second plane (not shown) of the optic 820 can be defined, the second plane being perpendicular to the plane of symmetry 860 and also including the central axis 832.

FIG. 8 schematically depicts a cross-sectional view of the optic 820 in the plane of symmetry 860. As discussed above with reference to FIGS. 1-4, the side portions 844a,b are planar though in other embodiments, they can present concave or convex surfaces to incident light rays. Thus, in this cross-sectional view, the planar side portions 844a,b are shown as line segments. In this embodiment, the line segments 844a and 844b form different angles α and β relative to the central axis 832. More specifically, in this embodiment, the angle α is about 60 degrees and the angle β is about 20 degrees. More generally, one of the angles (e.g., a) can be in a range of about 50 degrees to about 70 degrees and the other angle (e.g., α) can be in a range of about 10 degrees to about 30 degrees, though the configuration of the side output surfaces 844a,b and their arrangement relative to the input surface 828 can be modified to achieve a desired output light distribution, as otherwise discussed herein.

With continued reference to FIG. 8, a minimum distance between each side portion 844a,b and the central axis 832 in the plane of symmetry 860 can be defined as the distance between the central axis 832 and the intersection point 848a,b of a respective line segment 844a,b with the central portion 824, which distance can be characterized by the length of an orthogonal line segment that connects the intersection point 848a,b to the central axis 832 and is orthogonal to the central axis 832. For example, in this embodiment, the minimum distance between the side portion 844a and the central axis 832, defined by the length of the line segment L₁, is less than the minimum distance between the side output surface 844b and the central axis 832, defined by the length of the line segment L₂. Referring now to FIG. 9, the dotted lines represent boundary conditions of light rays exiting the optic 820 through the central portion 824 and side portions 844a,b, when emitted from a putative light source 810 and input into the optic at input surface 828. While these conditions refer to a point light source which provides substantially uniform illumination at the input surface 828, one of skill in the art will appreciate that such measures discussed below can be similarly used to approximate the boundary conditions of the optic 820 of a variety of light sources positioned at a variety of locations relative to the input surface 828.

The boundary line 900 represents the angle of the side portion 844b relative to the putative point light source 810 (i.e., β), as discussed above in reference to FIG. 8. Light that enters and traverses the optic 820 at an angle slightly greater than β relative to the central axis 832 (i.e., slightly clockwise of boundary line 900), is reflected from the most superior portion of sidewall 842b to the side portion 844b, and is thereby refracted to exit the optic 820 approximately along the boundary line 901. As shown, the boundary line 901 forms an angle of about α* relative to the central axis 832.

Light that enters and traverses the optic 820 at an angle slightly less than 90 degrees relative to the central axis 832 is reflected from the most inferior portion of sidewall 842b to the side portion 844b, and is thereby refracted to exit the optic 820 approximately along the boundary line 902, which as shown is approximately parallel to the central axis 832.

The boundary line 901 therefore represents the maximum exit angle of light that is reflected from the sidewall 842b, while the boundary line 902 represents the minimum exit angle of light that is reflected from the sidewall 842b. Accordingly, light emitted by a putative point light source 810 at an angle of between about 90 degrees relative to the central axis 832 and about β exits the side portion 844b within the boundaries defined by boundary lines 901 and 902 (i.e., at an angle between about 0 degree and about α*).

Conversely, the boundary line 903 represents the angle of the side portion 844a relative to the putative point light source 810 (i.e., a), as discussed above in reference to FIG. 8. Light that enters and traverses the optic 820 at an angle slightly greater than α relative to the central axis 832 (i.e., slightly counterclockwise of boundary line 903), is reflected from the most superior portion of sidewall 842a to the side portion 844a, and is thereby refracted to exit the optic 820 approximately along the boundary line 904. As shown, the boundary line 904 forms an angle of about β* relative to the central axis 832.

Light that enters and traverses the optic 820 at an angle slightly less than 90 degrees relative to the central axis 832 is reflected from the most inferior portion of sidewall 842a to the side portion 844a, and is thereby refracted to exit the optic 820 approximately along the boundary line 905, which as shown is approximately parallel to the central axis 832.

The boundary line 904 therefore represents the maximum exit angle of light that is reflected from the sidewall 842a while the boundary line 905 represents the minimum exit angle of light that is reflected from the sidewall 842a. Accordingly, light emitted by a putative point light source 810 at an angle of between about 90 degrees and about a relative to the central axis 832 exits the side portion 844a within the boundaries defined by boundary lines 904 and 905 (i.e., at an angle between about 0 degree and about β*).

On the other hand, light that enters the optic 820 at an angle slightly less than β relative to the central axis 832 (i.e., slightly counterclockwise of boundary line 900), is thereby refracted by the central portion 824 at an angle of about β relative to the central axis. On the other side of the central portion 824 (i.e. to the left in FIG. 9), light that enters the optic 820 at an angle slightly less than α relative to the central axis 832 (i.e., slightly clockwise of boundary line 903), is thereby refracted by the central portion 824 at an angle of about a relative to the central axis.

In the exemplary embodiment depicted in FIG. 9, the side portions 844a,b are therefore configured to act as cutoffs by redirecting light received from the input surface into an illumination area generated by the light exiting the optic through the central portion 824. In this manner, the side portions 844a,b prevent glare and increase the efficiency of the light source (e.g., by preventing light from being directed outside of the desired illumination area). By way of example, light emitted from the central surface 824 on one side of the central axis 832 (e.g., to the right in FIG. 9) exhibits a maximum divergence angle relative to the central axis 832 of about β in the plane of symmetry, while the light exiting the side portion 844a on the opposed side exhibits an angular divergence of about α. In some embodiments, β* is equal to or less than β such that one edge of the illumination pattern generated by the optic 820 in the plane of symmetry is restricted by α (i.e., boundary line 904 will not intersect boundary line 900). Conversely, on the other side of the central axis 832 (e.g., to the left in FIG. 9), light emitted from the central surface 824 exhibits a maximum divergence angle of about a relative to the central axis 832 in the plane of symmetry, while the light exiting the side portion 844b exhibits an angular divergence of about α*. In some embodiments, α* is equal to or less than α such that one edge of the illumination pattern generated by the optic 820 in the plane of symmetry is restricted by α (i.e., boundary line 901 will not intersect boundary line 903). In this manner, the light rays exiting the side portions 844a,b are confined within the illumination pattern generated by the central surface 824.

As shown in FIG. 9, the sidewalls 842a and 842b are configured and positioned relative to the input surface 828 such that the angular divergence of the light rays received by the sidewall 842b via the input surface 828 is greater than the angular divergence of those light rays received by the sidewall 842b via the input surface 828. By way of example, in this embodiment, the light rays entering the optic via the input surface 828 in the plane of symmetry 860 received by the sidewall 842a exhibit an angular divergence of about (90-α) degrees, which is less than the angular divergence of about (90-β) degrees of the light rays in the plane of symmetry 860 received by sidewall 842b.

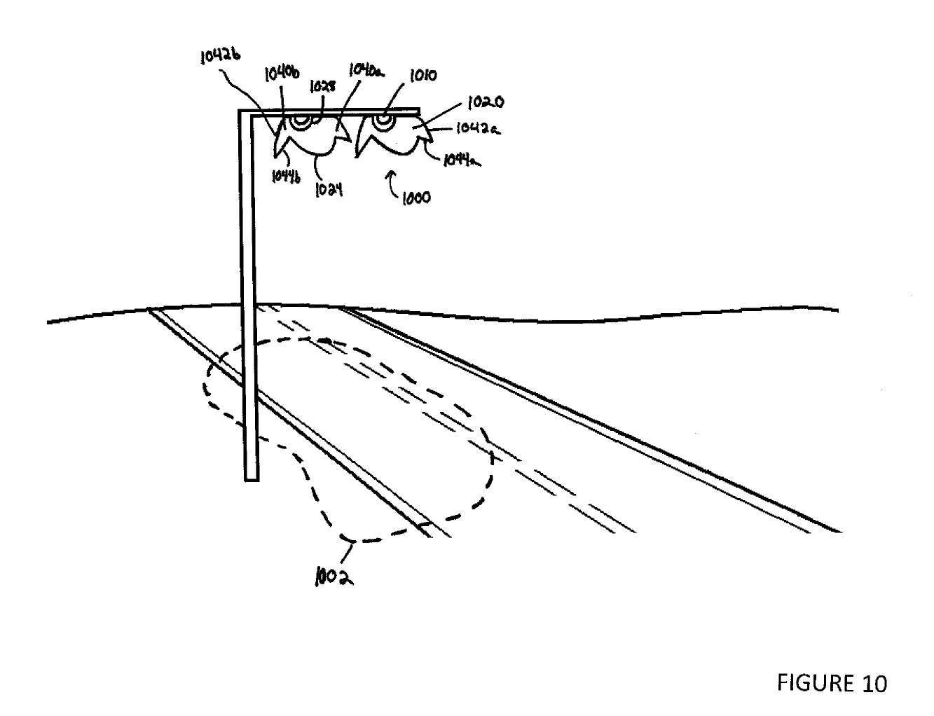

As noted above, the optics and lighting modules comprising the optic (e.g., optic 120) and a light source 110, such as an LED, can be utilized in a variety of applications. By way of example, FIG. 10 schematically depicts such an application in which the optic(s) 1020 and an LED 1010 are employed as a lighting module 1000 for illuminating a street surface. The lighting modules 1000 are mounted on a pole, which is disposed adjacent to a street, such that each individual lighting module 1000 directs light generated by the LED(s) 1010 onto a portion of the street surface so as to generate a substantially rectangular illumination area 1002 thereon (as shown by the dotted line). More specifically, in the depicted embodiment, a plurality of lighting modules 1000 are mounted on the pole such that the LED 1010 is mounted above the optic 1000 and its central output surface 1024 and the side output surfaces 1044a,b face downward. Further, each optic 1020 can be mounted on the pole such that the side portion 1040a is distal to the pole and the other side portion 1040b is proximal to the pole such that a plane of symmetry of the optic 1020 extends across the street while the plane perpendicular to the plane of symmetry and containing the central propagation axis runs along the length of the street. Any number of lighting modules 1000 can be used, and the modules 1000 can be disposed in a variety of patterns (e.g., in an array). For example, the lighting modules may be aligned side-by-side or such that their side portions 1040a,b are adjacent. The modules 1000 can also be positioned relative to one another such that the pattern 1002 generated by each individual module 1000 at least partially overlaps (and in some cases substantially coincides) with the illumination pattern(s) generated by one or more of the other modules to form a desired illumination pattern.

In the embodiment depicted in FIG. 10, in which the light sources 1010 emit light characterized by a central propagation axis, the modules 1000 can be mounted such that said central propagation axis is substantially parallel with a central longitudinal axis of the pole. Nonetheless, the modules 1000 can be effective to preferentially direct a majority of the light to the target surface, even if the module is not disposed directly over that surface. Indeed, the optics 1020 can be configured such that light rays exiting the central output surface 1024 diverge asymmetrically relative to the central propagation axis to generate an asymmetric illumination pattern on the target surface. That is, the optics 1020 can redirect light rays out of the optic 1020 such that the illumination pattern (characterized by an intensity distribution of light) generated by the light rays exiting the optic 1020 on a target surface perpendicular to the central axis lacks rotational symmetry. By way of example, the central output surface 1024 in the plane of symmetry can diverge light asymmetrically relative to the central propagation axis. In one embodiment, light rays exiting the central output surface 1024 in the plane of symmetry can exhibit a maximum divergence angle relative to the central propagation axis on a distal side of the central propagation axis that is greater than a maximum divergence angle relative to the central propagation axis on a proximal side of the central propagation axis. In this manner, light can preferentially be directed by the central output surface 1024 distally (i.e., toward the center of the street).

Accordingly, as discussed otherwise herein, each optic 1020 can redirect the light generated by the LED 1010 to produce an asymmetric illumination pattern 1002. By way of example, the central refractive portion 1024 of each optic 1020 can output light incident thereon to generate the asymmetric lighting pattern 1002. For example, an optic 1020 oriented such that the plane of symmetry extends across the street outputs light along the length of the street according to the maximum divergence angle relative to the central propagation axis of the light rays exiting the central output surface 1024 in the plane perpendicular to the plane of symmetry and containing the central propagation axis (e.g., as discussed above in reference to FIG. 6, light exiting optic 120 in the second plane 162 exits the optic 120 symmetrically about the central propagation axis 112).

On the other hand, the distribution across the width of the street (i.e., in the plane of symmetry and planes parallel thereto) can be restricted based on the configuration of the central portion and/or the angle of the side output surfaces 1044a,b relative to the light source 1010 and their position relative to the input surface 1028. For example, in some embodiments, the optic 1020 can be configured such that a maximum divergence angle relative to the central propagation axis of light rays exiting the central output surface 1024 on the distal side of the central propagation axis is equal to or greater than an angular divergence of light rays exiting the proximal output surface 1044b in the plane of symmetry. Similarly, the optic 1020 can be configured such that a maximum divergence angle relative to the central propagation axis of light rays exiting the central output surface 1024 on the proximal side of the central propagation axis is equal to or greater than an angular divergence of light rays exiting the distal output surface 1044a in the plane of symmetry. In this manner, the distal end of the central output surface 1024 restricts the distal edge of the asymmetric illumination pattern 1002 while the proximal end of the central output surface 1024 (e.g., the portion near the proximal output surface 1044b) restricts the proximal edge of the asymmetric illumination pattern 1002. In this manner, light can be preferentially directed away from the light pole such that a majority of the light is distributed on the target surface (e.g., the street). As discussed otherwise herein, the side portions 1040a,b can thereby act as cutoffs to prevent light from exiting the optic 1020 at undesirable angles, which could inefficiently illuminate the target surface or miss the target surface. The side portions 1040a,b can be effective to redistribute light from the input surfaces directed thereat to the asymmetric illumination pattern 1002 generated by the central output surface 1024, thereby improving the efficiency of the street lighting system and increasing the intensity and in some cases the uniformity of the light throughout the pattern 1002.

Further, the distal and proximal side portions 1040a,b and their respective components (e.g., the distal and proximal sidewalls 1042a,b and the distal and proximal output surfaces 1044a,b) can have the same or different shapes and or configurations. In the depicted embodiment, the distal side portion 1042a is generally smaller than that of the proximal side portion 1042b. The size of the proximal side portion 1042b and the more acute angle of the side output surface 1044b relative to the central propagation axis enable directing less light toward the pole (and therefore towards a house adjacent the pole side of the street). Additionally, differences in the configurations of the side portions 1040a,b can be important to alter the light cut-off angle for various light distribution requirements. For example, the desired illumination pattern for a residential street may be different than for a major motorway. The side portions 1040a,b can be sized and configured to allow for balancing the efficiency and light control. By way of example, the proximal side portion 1044b can be configured to form a more acute angle with the central axis so as to provide less light towards the pole side of the central axis. Similarly, the distal side portion 1044a can be tilted at a more obtuse angle relative to the central axis to allow the optic 1020 to provide an illumination pattern with a greater width across the width of the street.

The present application also provides an exemplary method of designing a lens configured to produce an asymmetric illumination pattern on a target surface area. For ease of reference, the following description will use terminology similar to that used above in connection with FIG. 1, but this should not be construed to mean that the optic 120 shown in FIG. 1 must be designed in accordance with the following principles or that FIG. 1 represents a result of performing every part of this exemplary design process. The design of such a lens can involve the use of a computer aided-model for designing optics and/or simulating the light produced by such optics. In one exemplary approach, the design of a lens can be viewed as a series of design goals or parameters for each surface or lens element of the optic.

For example, in some embodiments, the central output surface 124 can be designed by starting with an initial surface profile and iteratively changing the profile (e.g., by changing one or more parameters) based on a ray-tracing simulation of an asymmetric pattern generated by each profile relative to light received from a previously defined input surface until a desired illumination profile is achieved. The input surface 128, side portions 140a,b can then be designed to preferentially direct light to various portions of the asymmetric lighting pattern and/or so as to increase uniformity of the desired illumination pattern and reduce the occurrence of glare. By way of example, optics and lighting systems made in accordance with the principles described herein can in some cases produce an asymmetric illumination area having a substantially uniform light intensity throughout the illumination area.

Indeed, an optic 120 can be designed in light of the teachings herein to create a variety of illumination patterns. As will be appreciated by the person of skill in the art, the exemplary optics described can be modified such that the general components (e.g., the superior surface 124 of the central refractive portion 122) can be configured and arranged to generate a desired illumination pattern. For example, the optic 120 can be made of various lengths, widths, or depths, and the size and arrangement of the input surface 128, central refractive portion 122, and side portions 140a,b relative to one another can be selected to achieve a desired output light distribution.

Texture, micro-lenses, micro-prisms, micro-cylinders, or other light-controlling structures can be added to the output surface, or any portion thereof, to achieve desired optical effects, e.g., to improve the uniformity of the light.

Optics and lighting systems made in accordance with the principles described herein can, in some cases, provide a variety of advantages. For example, in some embodiments, the side portions can prevent light rays emitted by the sources from diverging beyond a desired angle relative to the central axis of the input surface or central propagation axis of the light source. In some embodiments, the optics can reduce or avoid glare and/or improve the efficiency in illuminating the target area, and/or improve the uniformity of light of the desired illumination area.

Optics and lighting systems made in accordance with the principles described herein can, in some cases, provide an efficiency of at least about 80%, where efficiency is measured as the ratio of total source light to total light exiting the optic, for example, to illuminate a target surface. In other embodiments, such an optic and/or lighting system can exhibit at least about 50% efficiency, at least about 60% efficiency, at least about 70% efficiency, or at least about 75% efficiency.

It should be noted that the foregoing discussion is not intended to necessarily describe optimal results that can be achieved or that need to be achieved by employing an optic or lighting system in accordance with the teachings of the invention, but merely to illustrate exemplary advantages that may be possible in certain applications.

Any of the foregoing optics (e.g., any of the lens bodies illustrated and/or described in connection with FIGS. 1-10) can be formed as a unitary structure. For example, with reference to the optic of FIG. 1, though the central refractive portion 122 and side portions 140a,b are described as distinct portions of the optic 120, these “portions” of the optic 120 can form a continuous, physically undivided structure (which in many embodiments is formed of substantially the same material composition throughout). In other embodiments, different portions of the optic can be assembled as separate units, e.g., via physical and/or optical coupling.

The optics described herein can be made of a variety of materials. By way of non-limiting example, any of the lenses or other optics described herein can be made of polymethyl methacrylate (PMMA), glass, polycarbonate, cyclic olefin copolymer and cyclic olefin polymer, or any other suitable material.

The optics described herein can be fabricated by utilizing a variety of different methods. By way of non-limiting example, the optic 120 can be formed by injection molding, by mechanically cutting an optic from a block of source material and/or polishing it, by forming a sheet of metal over a spinning mandrel, by pressing a sheet of metal between tooling die representing the final surface geometry including any local facet detail, and so on. In some embodiments, reflective surfaces can be created by a vacuum metallization process which deposits a reflective metallic (e.g., aluminum) coating, by using highly reflective metal substrates via spinning or forming processes. Faceting on reflective surfaces can be created by injection molding, by mechanically cutting a reflector or lens from a block of source material and/or polishing it, by pressing a sheet of metal between tooling die representing the final surface geometry including any local facet detail, and so on.

Any publications or patent applications referred to herein, as well the appended claims, are incorporated by reference herein and are considered to represent part of the disclosure and detailed description of this patent application. Moreover, it should be understood that the features illustrated or described in connection with any exemplary embodiment may be combined with the features of any other embodiments. Such modifications and variations are intended to be within the scope of the present patent application.

What is claimed is:

1. An optic comprising:
an input surface adapted for receiving light from a light source,
an output surface having a central portion and a pair of side portions, and
a pair of reflective sidewalls,
said central portion of the output surface being positioned relative to said input surface and having a surface profile such that it refracts light incident thereon via the input surface asymmetrically out of the optic,
wherein each of said reflective sidewalls is adapted to reflect light incident thereon via the input surface to a respective one of said side portions of the output surface for exiting the optic.

2. The optic of claim 1, wherein said input surface exhibits rotational symmetry about an axis (“central axis”).

3. The optic of claim 2, wherein said optic exhibits a plane of symmetry and said central axis lies in said plane of symmetry.

4. The optic of claim 3, wherein light rays exiting the central portion of the output surface in said plane of symmetry diverge asymmetrically relative to said central axis.

5. The optic of claim 3, wherein light rays exiting the optic through the central portion of the output surface in said plane of symmetry exhibit a maximum divergence angle relative to the central axis on one side of the central axis that is different from a respective maximum divergence angle relative to the central axis on an opposed side of the central axis.

6. The optic of claim 5, wherein a maximum divergence angle relative to the central axis of light rays exiting the central portion of the output surface in the plane of symmetry on one side of the central axis is equal to or greater than an angular divergence angle of light rays exiting the optic in said plane of symmetry through a side portion of the output surface located on an opposed side of the central axis.

7. The optic of claim 3, wherein a maximum divergence angle relative to the central axis of light rays exiting the optic in said plane of symmetry is less than a maximum divergence angle relative to the central axis of the light rays exiting the optic in another plane (“second plane”) that contains the central axis and is perpendicular to said plane of symmetry.

8. The optic of claim 7, wherein said optic is asymmetric about said second plane.

9. The optic of claim 8, wherein light rays exiting the central portion of the output surface in said second plane diverge symmetrically relative to said central axis.

10. The optic of claim 9, wherein light rays in the second plane exhibit a maximum divergence angle relative to the central axis of about 70 degrees on each side of the central axis.

11. The optic of claim 3, wherein the pair of reflective sidewalls comprises first and second sidewalls, and wherein an angular divergence of light received by the first sidewall from the input surface in the plane of symmetry is less than an angular divergence of light received by the second sidewall from the input surface in the plane of symmetry.

12. The optic of claim 11, wherein a minimum distance between the first sidewall and the central axis is greater than a minimum distance between the second sidewall and the central axis in the plane of symmetry.

13. The optic of claim 11, wherein the side portions associated with the first and second sidewalls intersect the central portion of the output surface at an intersection point, and wherein the minimum distance between the central axis and the intersection point on one side of the central axis is greater than on the opposed side of the central axis.

14. The optic of claim 11, wherein said central portion of the output surface is positioned relative to the input surface such that a majority of light rays in the plane of symmetry incident on the central portion of the output surface is refracted toward one side of the central axis relative to the other side.

15. The optic of claim 11, wherein said central portion of the output surface is positioned relative to the input surface such that light rays in the plane of symmetry exit said central portion of the output surface at an angle relative to the central axis in a range of about 0 degree to about 60 degrees on a first side of the central axis and from about 0 degree to about 20 degrees relative to the central axis on a second side of the central axis.

16. The optic of claim 15, wherein the side portion of the output surface associated with the sidewall on said first side of the central axis (“first side output surface”) is configured such that light rays in the plane of symmetry exiting said first side output surface exhibit an angular divergence of about 20 degrees.

17. The optic of claim 15, wherein the side portion of the output surface associated with the sidewall on said second side of the central axis (“second side output surface”) is configured such that light rays in the plane of symmetry exiting said second side output surface exhibit an angular divergence of about 60.

18. The optic of claim 1, wherein the reflective sidewalls are configured to reflect light incident thereon via total internal reflection.

19. The optic of claim 1, wherein the reflective sidewalls are configured to reflect light incident thereon via specular reflection.

20. The optic of the claim 19, wherein the reflective sidewalls are metalized.

21. The optic of claim 1, wherein optic comprises a unitary structure.

22. The optic of claim 21, wherein said optic is formed at least partially of one of polymethyl methacrylate (PMMA), glass, polycarbonate, cyclic olefin copolymer and cyclic olefin polymer.

23. The optic of claim 1, wherein said central portion of the output surface comprises a surface having two lobes.

24. The optic of claim 1, wherein said side portions of the output surface are substantially planar.

25. The optic of claim 3, wherein one of said side portions forms an angle in the plane of symmetry in a range of about 50 degrees to about 70 degrees relative to said central axis and the other of said side portions forms an angle in a range in the plane of symmetry of about 30 degrees to about 10 degrees relative to said central axis.

26. The optic of claim 25, wherein one of said side portions forms an angle in the plane of symmetry of about 60 degrees relative to said central axis and the other of said side portions forms and angle in the plane of symmetry of about 20 degrees relative to said central axis.

27. The optic of claim 1, wherein said input surface lacks rotational symmetry.

28. An optical system comprising:
a light source, and
an optic having an inferior surface, a superior surface, and a pair of sidewalls extending therebetween,
wherein the inferior surface comprises an input portion for receiving light from the light source, the input portion forming a cavity for housing the light source,
wherein the superior surface comprises a central portion and two side portions, said central portion of the superior surface being adapted to refract at least a portion of the light received through the input portion out of the optic so as to generate an asymmetric illumination area on a target surface, and
wherein the sidewalls are adapted to reflect at least a portion of the light received through the input portion to a respective side portion of the superior surface such that each side portion of the superior surface refracts light incident thereon out of the optic to said asymmetric illumination area.

29. The system of claim 28, wherein said optic comprises a unitary structure.

30. The system of claim 28, wherein said side portions of the superior surface are planar.

31. The system of claim 28, wherein the side portions of the superior surface have different surface areas.

32. The system of claim 28, wherein said light source emits light characterized by a central propagation axis.

33. The system of claim 32, wherein said optic exhibits a plane of symmetry and said central propagation axis lies in a plane through which the optic exhibits minor symmetry (“a plane of symmetry”).

34. The system of claim 33, wherein said side portions of the superior surface are substantially planar.

35. The system of claim 34, wherein said side portions of the superior surface have different angles in said plane of symmetry relative to said central propagation axis.

36. The system of claim 33, wherein a minimum distance between one side portion of the superior surface and the central propagation axis is greater than a minimum distance between the other side portion of the superior surface and the central propagation axis.

37. The system of claim 33, the optic is configured such that light rays exiting the optic through the central portion of the superior surface diverge asymmetrically relative to said central propagation axis.

38. The system of claim 33, the optic is configured such that light rays exiting the optic through the central portion of the superior surface in said plane of symmetry exhibit a maximum divergence angle relative to the central propagation axis on one side of the central propagation axis that is different from a maximum divergence angle relative to the central propagation axis on an opposed side of the central propagation axis.

39. The system of claim 33, the optic is configured such that a maximum divergence angle relative to the central propagation axis of light rays exiting the optic through the central portion of the superior surface in the plane of symmetry on one side of the central propagation axis is equal to or greater than an angular divergence of light rays exiting the optic through a side portion of the superior surface that is located on an opposed side of the central propagation axis.

40. The system of claim 33, the optic is configured such that a maximum divergence angle relative to the central propagation axis of light rays exiting the optic through said superior surface in said plane of symmetry is less than a maximum divergence angle relative to the central propagation axis of the light rays exiting the optic through said superior surface in another plane (“second plane”) that contains the central propagation axis and is perpendicular to said plane of symmetry.

41. The system of claim 40, wherein said optic is asymmetric about said second plane.

42. The system of claim 41, wherein light rays exiting the central portion of the superior surface in said second plane diverge symmetrically relative to said central propagation axis in the second plane.

43. The system of claim 33, wherein the optic is positioned relative to the light source such that a majority of light rays exiting the optic in the plane of symmetry are preferentially refracted away from the central propagation axis and toward one side of the central propagation axis relative to the other side.

44. The system of claim 28, wherein said input surface exhibits rotational symmetry about an axis (“central axis”).

45. The system of claim 44, wherein said light source emits light characterized by a central propagation axis and wherein said central axis and said central propagation axis are aligned.

46. The system of claim 44, wherein the minimum distance between one side portion of the superior surface and the central axis is greater than a minimum distance between the other side portion of the superior surface and the central axis.

47. A lighting system, comprising:
a pole disposed adjacent a target surface, and
at least one lighting module mounted on said pole, the lighting module comprising a light source and a optic for directing light from said source to said target surface,
wherein the optic comprises a central refractive portion and a pair of side portions, the central refractive portion having a cavity for at least receiving said light source and for coupling light from said light source into said optic,
said central refractive portion further having an output surface adapted to refract at least a portion of light received through the input surface out of the optic so as to generate an asymmetric illumination area on said target surface,
wherein each of the side portions is adapted to redirect via reflection and refraction at least portion of the light received through the input surface out of the optic to said asymmetric lighting area.

48. The system of claim 47, wherein the module is mounted such that one of said side portions (“proximal side portion”) is disposed proximal to said pole and the other of said side portions (“distal side portion”) is disposed distal to the pole.

49. The system of claim 47, wherein said light source emits light characterized by a central propagation axis.

50. The system of claim 49, wherein said module is mounted such that said central propagation axis is substantially parallel with a central longitudinal axis of the pole.

51. The optic of claim 49, wherein said optic exhibits a plane of symmetry and said central propagation axis lies in said plane of symmetry.

52. The optic of claim 51, the optic is configured such that light rays exiting the output surface of said central refractive portion in said plane of symmetry diverge asymmetrically relative to said central propagation axis.

53. The optic of claim 51, the optic is configured such that light rays exiting said output surface of the central refractive portion in said plane of symmetry exhibit a maximum divergence angle relative to the central propagation axis on a distal side of said central propagation axis that is greater than a maximum divergence angle relative to the central propagation axis on a proximal side of said central propagation axis.

54. The system of claim 53, wherein the proximal side portion comprises a proximal sidewall and a proximal output surface and the distal side portion comprises a distal sidewall and a distal output surface.

55. The system of claim 54, wherein said proximal sidewall is configured such that substantially all light received from the input surface at the proximal sidewall is reflected to exit the optic through the proximal output surface.

56. The system of claim 55, wherein a maximum divergence angle relative to the central propagation axis of light rays exiting said output surface of the central refractive portion in said plane of symmetry on said distal side of the central propagation axis is equal to or greater than an angular divergence of light rays exiting the proximal output surface in said plane of symmetry.

57. The system of claim 54, wherein said distal sidewall is configured such that substantially all light received from the input surface at the distal sidewall is reflected to exit the optic through the distal output surface.

58. The system of claim 57, wherein a maximum divergence angle relative to the central propagation axis of light rays exiting said output surface of the central refractive portion in said plane of symmetry on said proximal side of the central propagation axis is equal to or greater than an angular divergence of light rays exiting the distal output surface in said plane of symmetry.

59. The system of claim 54, wherein the optic is positioned relative to the light source such that in the plane of symmetry, a majority of light received through the input surface exits the output surface distal to the central propagation axis.
